(19) United States
(12) Patent Application Publication
(10) Pub. No.: US 2014/0304030 A1
(43) Pub. Date: Oct. 9, 2014

(54) SUPPLY CHAIN ARCHITECTURE

(71) Applicant: Andre Bryan, Cleveland, OH (US)

(72) Inventor: Andre Bryan, Cleveland, OH (US)

(21) Appl. No.: 14/244,573

(22) Filed: Apr. 3, 2014

Related U.S. Application Data
(60) Provisional application No. 61/807,822, filed on Apr. 3, 2013.

(51) Int. Cl. G06Q 10/06

(52) U.S. Cl. CPC G06Q 10/063
USPC 705/7.28; 705/7.11

(57) ABSTRACT

The disclosed architecture is an end-to-end supply chain audit and compliance architecture that enables users to capture pertinent supplier information throughout the entire supply chain, and conduct comprehensive risk analysis as part of due diligence compliance efforts. The architecture find particular applicability to monitoring the origin and introduction into the supply chain of conflict minerals, such as gold, diamonds, oil, etc., that have been obtained illegally or against moral and ethical standards. The architecture also enables the exposure of forced labor sources, counterfeit materials, and false quality certifications.

### CROSS-REFERENCE TO RELATED APPLICATIONS

This application claims the benefit of U.S. Provisional Patent application Ser. No. 61/807,822 entitled “SUPPLY CHAIN AUDIT SYSTEM AND RELATED METHODS” and filed Apr. 3, 2013, the entirety of which is incorporated by reference herein.

### BACKGROUND

Participation in national and international markets introduces significant challenges to ensuring that end products meet quality and supply chain requirements, as well as regulatory laws. Consumers rely on the products they purchase meet all regulatory, quality control, ethical, and moral standards from manufacturing and assembly throughout the supply chain.

Supply chain code of conduct is increasingly recognized as a key component of corporate responsibility. Managing the social, environmental and economic impacts of supply chains, and combating corruption, international atrocities, forced labor practices, makes good business sense, as well as being the right thing to do. However, supply chains consist of many challenges including continuously evolving markets, business environments and relationships.

Primary among these challenges are: compliance with laws and regulations, and adherence and support of international principles for sustainable business conduct. In addition, companies are increasingly taking actions that result in better social, economic, and environmental impacts because society expects this and because there are business benefits to doing so. Moreover, raw materials obtained using means that impact human rights standards are also a significant concern. Accordingly, there needs to be an end-to-end compliance architecture that can audit supply chains in accordance with national and international corporate compliance rules and laws.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is an end-to-end supply chain audit and compliance architecture that enables users to capture pertinent supplier information throughout the entire supply chain, and conduct comprehensive risk analysis as part of due diligence compliance efforts. The architecture finds particular applicability to monitoring the origin and introduction into the supply chain of conflict minerals, such as gold, diamonds, oil, etc., that have been obtained illegally or against moral and ethical standards. The architecture also enables the exposure of forced labor sources, counterfeit materials, and false quality certifications.

The disclosed architecture provides the capability to conduct supply chain audits, identify and assess risks associated with suppliers, manufacturers, and products in the supply chain, and report findings of the supply chain risk assessment to the designated senior management of the company. Additionally, legal responsibilities can be assessed at least with regards to conflict minerals. The architecture employs key performance indicators for measuring improvement (e.g., a percentage), rules for measuring the level of non-compliant suppliers (e.g., a range), and enables a continuous improvement process.

The architecture enables the capability to provide due diligence. A system of controls and transparency is enabled over the supply chain. This includes a chain of custody or a traceability system or the identification of upstream actors in the supply chain. The architecture can be implemented through cloud-based computer programs.

Third-party audits are enabled. Through the initial supply chain audit, areas that require periodic or constant third party monitoring can be identified. Additionally, non-compliance issues identified through the software application are enabled with a trigger for independent third party audits.

The architecture provides monitoring and issue resolution. Corrective action plans can be developed and adopted, as well as strategies for compliance for continued raw materials obtainment, manufacture, and distribution throughout the implementation of corrective measures (e.g., agreed upon by senior management in writing). Selected transactions and tasks up and down the supply chain may be temporarily suspended while pursuing ongoing corrective actions. Moreover, complete disengagement with a supplier can be realized after failed attempts at mitigation or where a supplier deems compliance not feasible or unnecessary.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system of the disclosed supply chain architecture.

FIG. 3 illustrates a method in accordance with the disclosed architecture.

FIG. 4 illustrates an alternative method in accordance with the disclosed architecture.

FIG. 5 illustrates yet another alternative method in accordance with the disclosed architecture directed specifically to conflict minerals.

FIG. 6 illustrates a graphical depiction of a supply chain.

FIG. 7 illustrates a validation chain in the supply chain according to an embodiment.

FIG. 8 illustrates a graphical representation of validating and monitoring the compliance status of prospective suppliers.

FIG. 9 illustrates a flow diagram of the population and interrogation of a database.

FIG. 10 illustrates a flow diagram of compliance validation of a portion of the validation chain shown in FIG. 7.

FIG. 11 illustrates a reporting methodology according to one embodiment, wherein a set of supplier analytics is in communication with the central database.

FIG. 12 illustrates a bill-of-materials flow diagram.

FIG. 13 illustrates a flow diagram of an exemplary material analyzer.

FIG. 14 illustrates a flow diagram of case and incident management.

FIG. 15 illustrates a supplier on-board flow diagram.

FIG. 16 illustrates a flow diagram of an exemplary supplier/vendor analyzer.

FIG. 17 illustrates an exemplary user interface for presenting supply chain information.

FIG. 18 illustrates an exemplary user interface that shows a conflict minerals incident report for a year time span.

FIG. 19 illustrates a block diagram of a computing system that executes the supply chain architecture in accordance with the disclosed architecture.

### DETAILED DESCRIPTION

Consumers, investors, employees and other stakeholders have developed conscientiousness around corporate sustainability, environmental issues, human rights and corporate responsibility; and demand compliance and transparency.

Regulations whether federal, state, local, etc., place added pressure on businesses to ensure compliance. For example, the Dodd-Frank Act is expected to affect many industries, including electronics, industrial equipment and machinery, and aerospace, to name a few. The intent of the Act is an attempt to curb the violence and exploitation by exposing companies that use conflict minerals derived from Democratic Republic of Congo (DRC) through disclosure and public pressure. An SEC (Securities and Exchange Commission) registered company, which is a company that falls within the FCC (Federal Communications Commission) regulations, must furnish a report detailing the measures taken to exercise due diligence as to point of origin, chain of custody of the minerals, and the products that are not “DRC conflict free”.

The term ‘conflict minerals’ is defined to include cassiterite, columbite-tantalite, gold, worlframite, and associated derivatives, or any other minerals or associated derivatives determined by the Secretary of State to be financing conflict in the DRC countries. These conflict minerals may be referred to herein as “3T (tantalum, tungsten, tin) and gold (or 3TG)”. There is no de minimis exception, so companies that use even trace amounts of relevant materials in their products or in their manufacturing process will be impacted. If conflict minerals are necessary to the functionality or production of a product manufactured or contracted to be manufactured for a public company, the company must disclose annually whether the minerals originated in the Democratic Republic of the Congo or an adjoining country. Note that while the description herein may focus on conflict minerals, it is to be understood that the disclosed architecture can apply to any products and materials of a supply chain. An additional requirement is that the report must be audited by a third party.

The disclosed architecture is an end-to-end supply chain audit and compliance architecture that enables users to capture pertinent supplier information throughout the entire supply chain, and conduct comprehensive risk analysis as part of due diligence compliance efforts. The architecture find particular applicability to monitoring the origin and introduction into the supply chain of conflict minerals, such as gold, diamonds, oil, etc., that have been obtained illegally or against moral and ethical standards. The architecture also enables the exposure of forced labor sources, counterfeit materials, and false quality certifications.

The supply chain architecture operates according to many different types of alerts, which trigger specific actions or operations to occur. For example, the type of raw material or derivative thereof such as tin can trigger a specific flow (e.g., due diligence) to initiate in the architecture. Additionally, the sources of the mineral or material can serve to trigger yet again other processes within the disclosed architecture. For example, the country of origin of the material can be suspect, and thus, trigger processes to initiate in the supply chain. In another example, if materials are not coded as would be expected, this can serve as a trigger to begin an investigation within the supply chain, or as part of vetting a potential supplier. Thus, the architecture analyzes information submitted for a vendor to detect key words, materials, corporate names, individuals, material types, past history, nearby countries, countries of origin, etc., as possible trigger information. It may not be a single price of information that triggers a more detailed investigation of a potential supplier or existing supplier, but can be a combination of information that together trigger processes to take place to ensure the entity is suitable for the supply chain.

Inferences can be made based on the information provided and/or lack of information. For example, while one country of origin may have been politically stable when vetted as a source of raw materials, the country stability may have changed, which change can be a trigger to look with greater scrutiny at the country or supplier as a continuing source or role in the supply chain. Many different types of information need not necessarily be physically input for the disclosed architecture to operative for its intended purposes. For example, sources of information can be websites that track political conditions of countries, companies, and so on, and of which can serve as a trigger to look more carefully at a specific entity in the supply chain or trying to enter the supply chain. Other trigger information includes, but is not limited to, trade routes, shipping companies, accident reports, incidents, time to delivery, and so on.

As used herein a supply chain includes all business entities between a consumer and unprocessed raw materials, such as mined ore. As used herein the term participant, or supply chain participant, includes any business entity between a consumer and unprocessed raw materials. As used herein, the term supply chain management rule(s) includes any predetermined set of rules for managing the conduct of supply chain participants and/or the materials in a supply chain.

The disclosed architecture provides the capability to conduct supply chain audits, identify and assess risks associated with suppliers, manufacturers, and products in the supply chain, and report findings of the supply chain risk assessment to the designated senior management of the company. Additionally, legal responsibilities can be assessed at least with regards to conflict minerals. The architecture employs key performance indicators for measuring improvement (e.g., a percentage), rules for measuring the level of non-compliant suppliers (e.g., a range), and enables a continuous improvement process.

The architecture enables the capability to provide due diligence. A system of controls and transparency is enabled over the (mineral) supply chain. This includes a chain of custody or a traceability system or the identification of upstream actors in the supply chain. The architecture can be implemented through cloud-based computer programs.

Third-party audits are enabled. Through the initial supply chain audit, areas that require periodic or constant third party monitoring can be identified. Additionally, non-compliance issues identified through the software application are enabled with a trigger for independent third party audits.

The architecture provides monitoring and issue resolution. Corrective action plans can be developed and adopted, as well as strategies for compliance for continuing trade throughout the implementation of corrective measures (e.g., agreed upon by senior management in writing). Trade may be temporarily suspended while pursuing ongoing corrective actions. Moreover, complete disengagement with a supplier can be realized after failed attempts at mitigation or where a supplier deems compliance not feasible or unnecessary.

Following is an example of process for conflict mineral tracking. The process begins by collecting information via a questionnaire and storing this in the central database. Information collected can be from Tier₁, Tier₂, Tier₃ . . . Tierₘ suppliers, where Tierₘ suppliers can be smelters or miners, depending on the regulations. The architecture “connects the dots” from end-to-end by recording and displaying the connections between suppliers from Tier₁ through Tierₘ so as to provide a map of a supply chain for Tier₁.

Dashboards can provide information regarding alerts, tracking, investigation status, and reports, for example. Each supplier can be identified by a unique ID (identification) number (e.g., a DUNS (data universal numbering system) Number, FSC (federal supply class) Number, a unique national ID number, etc.), and links all Tier₁ and their sub-tier suppliers. The central database of the architecture can also comprise a searchable Harmonized Tariff Schedule (HTS) database and/or this database can be made part of an application program. Questionnaires capture not only company details, but also information on the product supplied and the suppliers from whom raw materials have been purchased, and information on constituent substances contained in the products that they acquire and sell.

In operation, a request is sent to a Tier₁ supplier for information on the products that it (supplier) sells and the sub-tier supplier(s) that it buys components/raw materials specific to those products. Basic details on the sub-tier suppliers are entered by the Tier₁ into the system. The Tier₁ supplier sends e-mail messages to all the involved sub-tier suppliers requesting them to log onto the system to complete one or more questionnaires. Automated messages can also be sent to the sub-tier suppliers by the system. Non-responding suppliers receive follow-up reminders that include phone calls.

If after follow-up reminders, there is still no response, then there is yet another follow-up. The deadline beyond which non-responsive suppliers are held in violation and face sanctions including removal from the supply chain, is defined. Suppliers from countries deemed high risk will warrant greater scrutiny and verification. Product profiles can be developed and integrated into the system to filter and trigger alerts. Alerts can be generated for reasons to include mismatch between HTS and the product description, a high risk (or probability) that conflict minerals are a major component in the product, and/or a smelter used that has been previously cited or sanctioned.

The architecture is modular for aspects of data collection, analysis, due diligence, and reporting. Additionally, each of these major modules can include modules that handle particular aspect of the architecture. As part of data collection for vetting a potential (prospective) supplier, a potential supplier is notified (e.g., email) and requested to respond through a DSC (designated supplier compliance) portal. When accessing the portal, the supplier is prompted to complete one or more questionnaires. These forms can include an IEC (International Electrotechnical Commission) Form 62474 REACH (Registration, Evaluation, Authorization and Restriction of Chemicals)/RoHS (Restriction of Hazardous Substances) and an IECC (Electronic Industry Citizenship Coalition)-GeSI (Global e-Sustainability Initiative) Conflict Minerals form, for example. Other forms can be provided according to the purposes of the supply chain and auditing.

The outputs of the questionnaire forms process can be to a Level 1 Risk Assessment process to assess the supplier as a low, medium or high level risk. Results of the IEC form and the IEEC form can also be sent directly to a separate data collection module as a Level 2 questionnaire. Data validation can be performed on the Conflict Mineral data as part of submission to the level 2 questionnaire. As part of a second module for data collection, output of the level 2 questionnaire can be to a level 2 risk assessment module that further processes the potential supplier information for some level of risk. At this point, the supplier can either be allowed into the supply chain, or denied access as a supplier in the supply chain.

The data collection module also comprises a supplier on-boarding module, such that once a potential supplier is vetted for the supply chain, steps are now taken to finalize the data collection process to bring the supplier “on line”. As part of completing the questionnaires, the supplier information is received into the database, and a list of components supplied to the company is recorded. As part of a due diligence module, a vendor and material list is created in an ERP (enterprise resource planning) system. The vendor and material list is also input to a supplier/vendor analyzer. The output of the analyzer is to a supplier on-boarding module and then to a material analyzer. Additionally, as part of due diligence, the list of components supplied to the company is imported and passed to the material analyzer. The new supplier is given a set time in which to complete all questionnaires. Once completed, the supplier manager is notified the task is complete, and flow is to final verification of the vendor questionnaire. The on-boarding module process then reaches an end point.

The analysis module comprises receipt of the above mentioned forms, performing level 1 risk assessment, feeding forward form information to a level 2 questionnaire, data validation of the conflict minerals form to the level 2 questionnaire, and finally, level 2 risk assessment.

The due diligence module runs routinely in the central database to ensure continued compliance of all entities in the supply chain. If the central database detects a rule violation, flow is to next generate an alert, followed by opening a case and investigation. A supplier compliance plan is developed to rectify the violation and sent to the supplier. If the supplier corrects the issue, a report is made and stored in the central database. However, if the supplier does not correct the issue, flow is to take additional corrective action. This can include a more extensive audit of the supplier and additional corrective actions. If the supplier complies, a report is created and stored in the central database. If the supplier does not comply, a non-compliance report is generated and stored in the central database.

Communications for the due diligence can include sending emails or other types of digital communications to the supplier by ties, and the whole supply chain, if desired. Responses are then logged in the central database. Any non-responses can be followed up with additional automated messages, and if still no response, by enterprise/tier follow-up, and if still no response, by direct intervention. If there is still no response, a non-compliance report is generated that may result in the supplier being halted from further involvement in the supply chain. If at any time in the non-response loop, the supplier does respond, the response and details about the response are stored in the central database.

The central database information can be provided for risk assessment, the generation and updating of supplier profiles, to initiate an auditing process, and to generate reports for each of these, and for other purposes.

The reporting module of the central database receives module completion input and checks to determine if module reporting objectives have been met. If yes, the case record is closed, and internal report is generated, the report is communicated publicly and a report is filed to one or more governing bodies. If module reporting objectives are not met, an internal report is generated, other possible actions determined, and a final action report is generated. Flow is then to close the case record, file an internal report, communicate publicly, and file a report with the SEC.

Embodiments of the invention may include systems and/or methods for validating the compliance of participants in a supply chain with respect to a predetermined set of supply chain management rules. For example, an embodiment may include a centralized database containing records of one or more participants in a supply chain which may include an indication of their rules compliance status. Thus, a participant in a supply chain can validate the compliance status of its suppliers, who are also participants in the supply chain, and those suppliers can validate the status of their suppliers, and so on.

Accordingly, a participant at the consumer end of the supply chain may certify that its products, and the components from which they were made, originate from participants which are in compliance with a predetermined set of supply chain management rules. Furthermore, a participant at the consumer end may validate the entire supply chain all the way back to the suppliers of raw materials such as mined materials. Embodiments may include means for calculating the amount and/or percentage of non-compliant materials in a supply chain or in the inventory of a selected participant.

Some embodiments may comprise a process including providing a set of supply chain management rules. These rules may be used to generate a database of participants in the supply chain. Such a database may be generated by, for instance, conducting on-site inspections of participant facilities, and/or audits of participant business records. Other means of generating the database may include a participant answering a self-audit questionnaire or signing a declaration attesting to their own compliance. One skilled in the art will understand that some participants are higher risk than others, and may require more stringent compliance verification measures while others may be allowed to self-verify at least occasionally.

Furthermore, the database may be maintained by a central authority and/or data stream provider, and may be updated regularly including updating the compliance status of participants. Embodiments may include periodic audits or other periodic means for re-determining the compliance status of participants. For instance, yearly audits of participant records and/or site inspections of participant facilities may be required, and the results may be used to update the compliance status of participants. In some embodiments, compliance status and/or certifications may expire automatically after a predetermined period of time.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

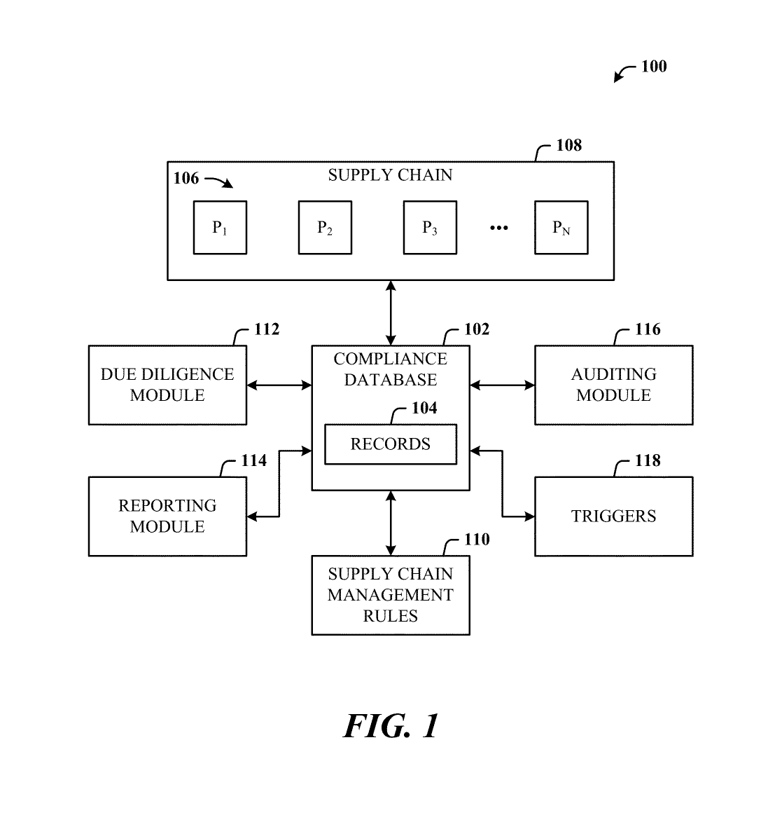

FIG. 1 illustrates a system 100 in accordance with the disclosed architecture. The system 100 can include a compliance database 102 (also referred to as a central database) configured to contain records 104 of participants (P_{1-N}) 106 in a supply chain 108 that may comprise a conflict mineral. Each participant record includes an indication of whether a participant is in compliance with supply chain management rules 110 for conflict minerals. The system 100 also comprises the supply chain management rules 110 configured to compare a first participant in the supply chain 108 to the compliance database 102, wherein a rule indicates compliance status of the first participant related to the supply chain management rules 110.

The compliance database 102 can further comprise or have an associated due diligence module 112 configured to enable risk analysis of a participant of the supply chain 108 as part of due diligence processing. The due diligence module 112 can be configured to run routinely (e.g., frequently, on a predetermined schedule, on-demand in response to triggers, etc.) to ensure continued compliance of all supply chain participants 106. The compliance database 102 can further comprise or have an associated reporting module 114 configured to ensure module reporting objectives have been met. The compliance database 102 enables compliance auditing (via an auditing module 116) from a supply chain participant in either direction of the supply chain 108. The compliance database 102 enables compliance processing based on rules that relate to raw material sources, raw material source locations, and geographical areas proximate the raw materials source.

The system 100 operates extensively based on triggers 118 (or alerts) that indicate the supply chain is operating properly or there may be events occurring that should be examined with scrutiny. One example is the number of certified smelter currently recognized under the IPC (formerly the Institute for Printed Circuits) is small, when in reality the number of non-certificated smelter is significantly greater. Thus, the reliability of the information coming from a given smelter or mine can be rated according to historical trustworthiness or some other metric. This trustworthiness can then improve over time or even become worse based on other sources of information (e.g., on-site contacts, contacts in the vicinity of the source, etc.) about the smelter or mine. Additionally, sensor sources can be the routes taken from the mine and/or smelter to move the product or raw material for processing and to next destinations in the material handling and processing operations. So information sources include, but are not limited to, human intelligence at the source, or near the source, documentation from the source, non-profit sources, and so on. Other triggers can include failures in the supply chain that can indicate substandard raw materials, parts manufacturers, and so on. Understanding the triggers/alerts is beneficial to deciding if further investigation is needed or not needed. Additionally, new laws and regulations can be fed into the disclosed architecture that may change the rules applied and so on.

Thus, the disclosed architecture enables an entity such as a company to make a business decision on some verifiable and validated way. Accordingly, the disclosed architecture can be applied to any item such as water, metals, and so on. The output of the architecture is a report that identifies all problem areas and/or supports business decisions to retain supply chain entities and even hire new entities.

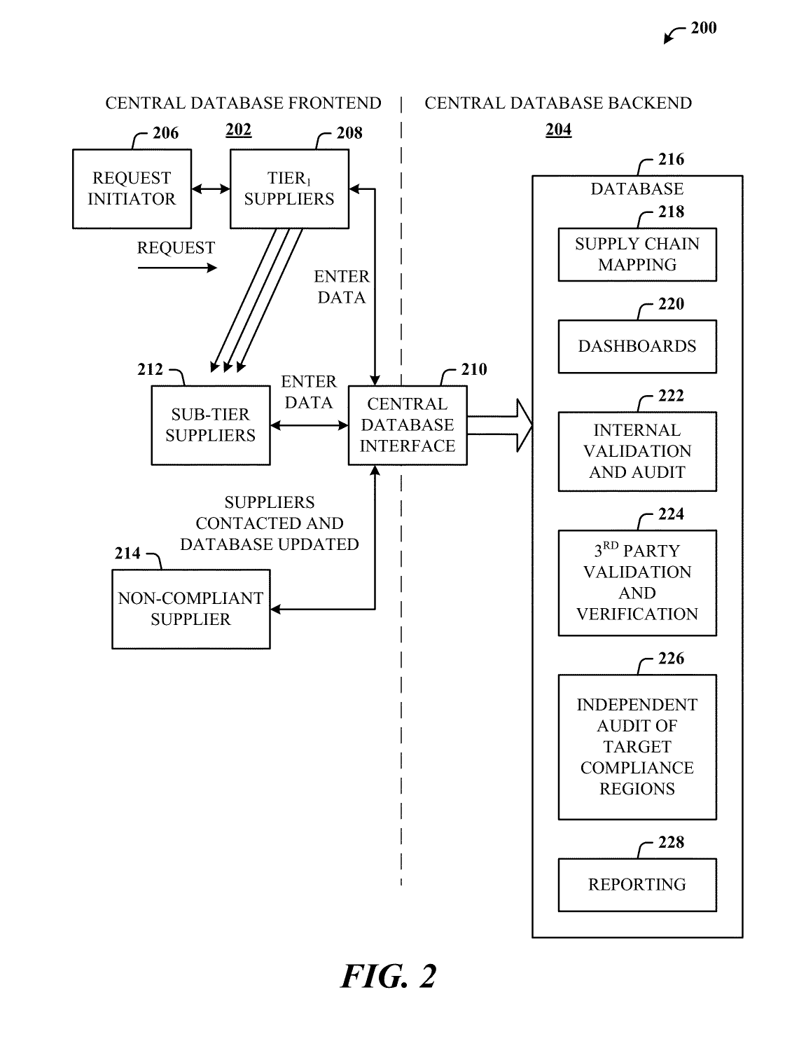

FIG. 2 illustrates an alternative system 200 of the disclosed supply chain architecture. This description introduces the concepts of a frontend 202 of the central database (the compliance database 102) and a backend 204 of the central database. As shown, the frontend 202 includes a request initiator 206 that operates to request information from candidate suppliers, to be part of Tier₁ suppliers 208. The Tier1 suppliers can send their data directly to the central database interface 210, and then further request or pass the requests to their sub-tier suppliers 212. The sub-tier suppliers can then also send the requested data directly to the central database interface 210. A non-compliant supplier 214 is prevented from access to the central database backend 204 via the interface 210. Additionally, suppliers that may have worked with the now non-compliant suppler when the now non-compliant supplier was considered a compliant supplier in the supply chain, can be notified, and the database is updated accordingly.

The database backend 204 comprises the central database 216 (also called the compliance database 102). The database 216 comprises at least the modules and capabilities to perform supply chain mapping 218, generate and present dashboards 220, support internal audit and validation 222, enable third-party validation and verification 224, enables independent auditing of target compliance regions 226 (e.g., mines in the DRC, etc.), and reporting 228.

Included herein is a set of flow charts and flow diagrams representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

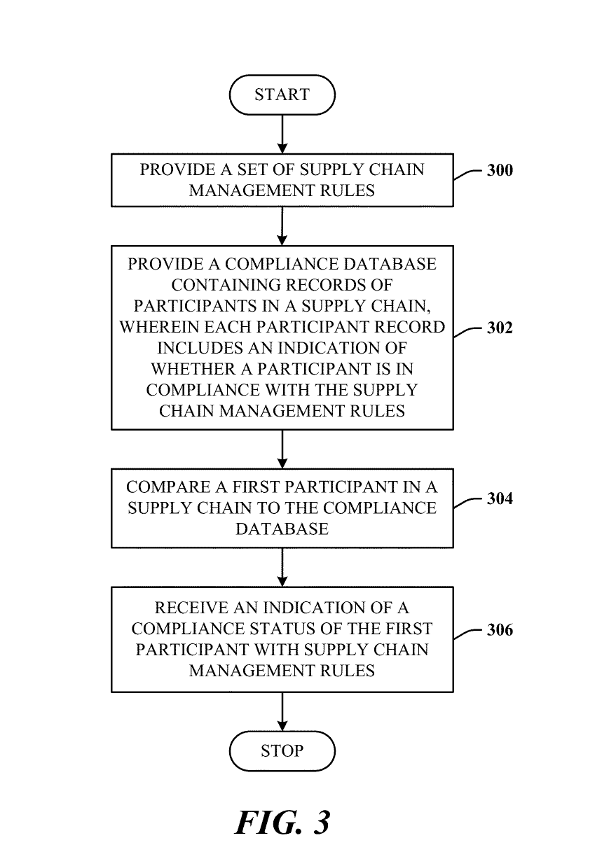

FIG. 3 illustrates a method in accordance with the disclosed architecture. At 300, a set of supply chain management rules is provided. At 302, a compliance database is provided that contains records of participants in a supply chain. Each participant record includes an indication of whether a participant is in compliance with the supply chain management rules. At 304, a first participant in a supply chain is compared to the compliance database. At 306, an indication is received of a compliance status of the first participant with supply chain management rules.

The participant in a supply chain comprises a network of participants in a supply chain, wherein each participant is individually selected from at least one of a retailer, a distributor of finished goods, a distributor of components, a finished goods manufacturer, a component manufacturer, a raw materials distributor, a raw materials manufacturer, a smelter, or a mining company. The plurality of supply chain participants access the compliance database to monitor the compliance status of respective direct and/or indirect suppliers.

The method can further comprise comparing a material obtainable from a participant supply chain to a list of materials subject to the supply chain management rules. The method can further comprise identifying a material obtainable from its supply chain as a material that is subject to the supply chain management rules.

The method can further comprise identifying at least one record of at least one prospective supplier from the compliance database which supplies the material, and wherein the at least one record includes at least one indicium indicating that the at least one prospective supplier is currently in compliance with the supply chain rules. The method can further comprise adding the at least one supplier to a list of preferred suppliers from which supplies are to be purchased.

The method can further comprise communicating the list of preferred suppliers to at least one purchasing agent within the participant. The method can further comprise tracing the material back to an original material source and determining that each participant between the original material source and a selected participant is in compliance with the supply chain management rules. The method can further comprise receiving an indication that a participant is noncompliant with the supply chain management rules.

The method can further comprise calculating an amount of material conveyed from noncompliant participant to a selected participant. The method can further comprise calculating the amount of noncompliant material conveyed from a noncompliant participant to a selected participant. The method can further comprise a percentage of noncompliant material conveyed to the selected participant. The method can further comprise determining the supply chain rules compliance status of the selected participant.

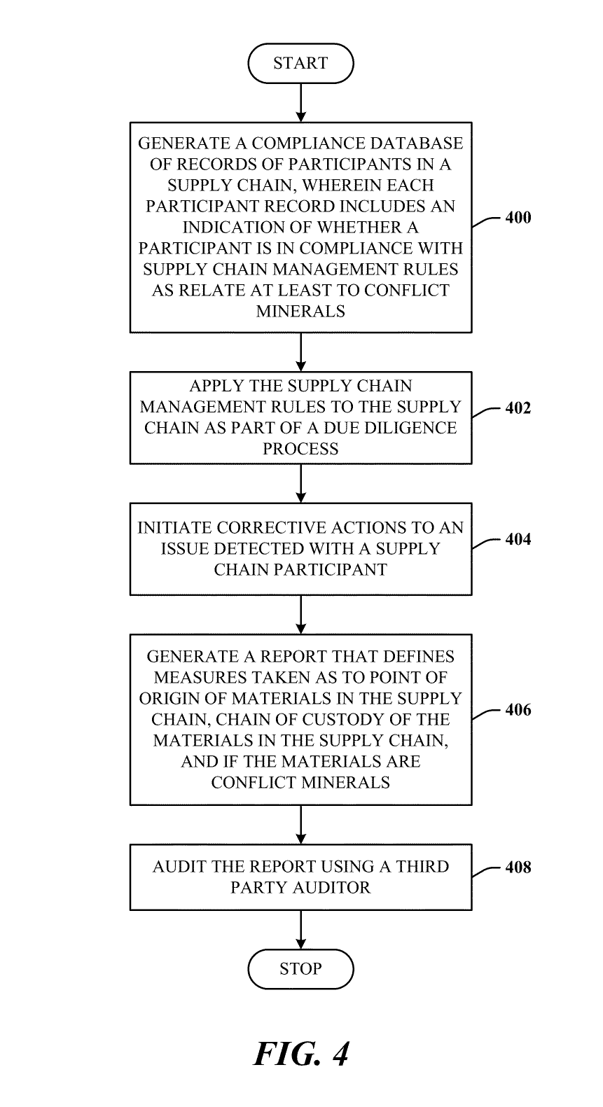

FIG. 4 illustrates an alternative method in accordance with the disclosed architecture. The method can be embodied in a computer-readable storage medium comprising computer-executable instructions that when executed by a hardware processor, cause the hardware processor to perform a supply chain method.

At 400, a compliance database of records of participants in a supply chain is generated, wherein each participant record includes an indication of whether a participant is in compliance with supply chain management rules as relate at least to conflict minerals. At 402, the supply chain management rules are applied to the supply chain as part of a due diligence process. At 404, corrective actions to an issue detected with a supply chain participant, are initiated. At 406, a report is generated that defines measures taken as to point of origin of materials in the supply chain, chain of custody of the materials in the supply chain, and if the materials are conflict minerals. At 408, the report is audited using a third party auditor.

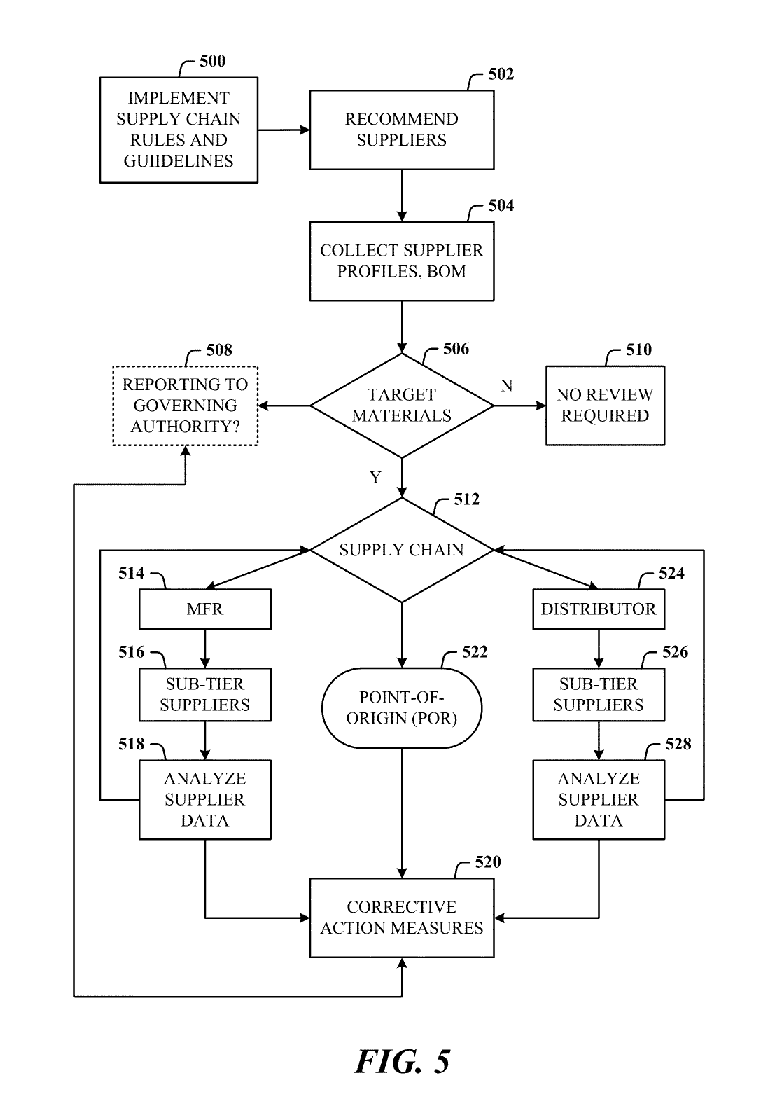

FIG. 5 illustrates yet another alternative method in accordance with the disclosed architecture directed specifically to conflict minerals. At 500, supply chain rules (and guidelines, e.g., OECD, etc.) are implemented. At 502, suppliers can be recommended. At 504, supplier profiles and BOMs are collected. At 506, a check is made for target materials (e.g., conflict minerals such as 3TG). If such materials are detected, optionally at 508, a report can be made to the governing authority (e.g., SEC, etc.). An additional step prior to reporting to the governing body at 508 can be to determine if the target materials are recycled and/or scrap materials, whether the target materials are conflict minerals or not. At 506, if no such target materials are detected, no review may be required, as indicated at 510, and no further processing may be needed.

If the target materials (e.g., conflict minerals) are detected, at 506, flow can continue to 512 determine the supply chain entity; if the supplier is a manufacturer, distributor, or point-of-origin (POR) (e.g., sources such as a smelter, mine, etc.). If a manufacturer, at 514, flow can continue to 516 to determine the sub-tier suppliers for this manufacturer. At 518, the supplier data is analyzed, and if needed, flow is to 520 to perform corrective action measures, and then send a report to the governing authority, at 508. Additionally, flow is back to the decision block 512 to again perform the check.

If the supply chain entity is a POR, flow is to determine the point-of-origin of the entity, at 522, and then to 520, to consider the corrective action measures. If the supply chain entity is a distributor, at 524, flow to 526 to determine the sub-tier suppliers for this distributor. At 528, the supplier data is analyzed, and if needed, flow is to 520 to perform corrective action measures. Additionally, flow is back to the decision block 512 to again perform the checks for the next entity.

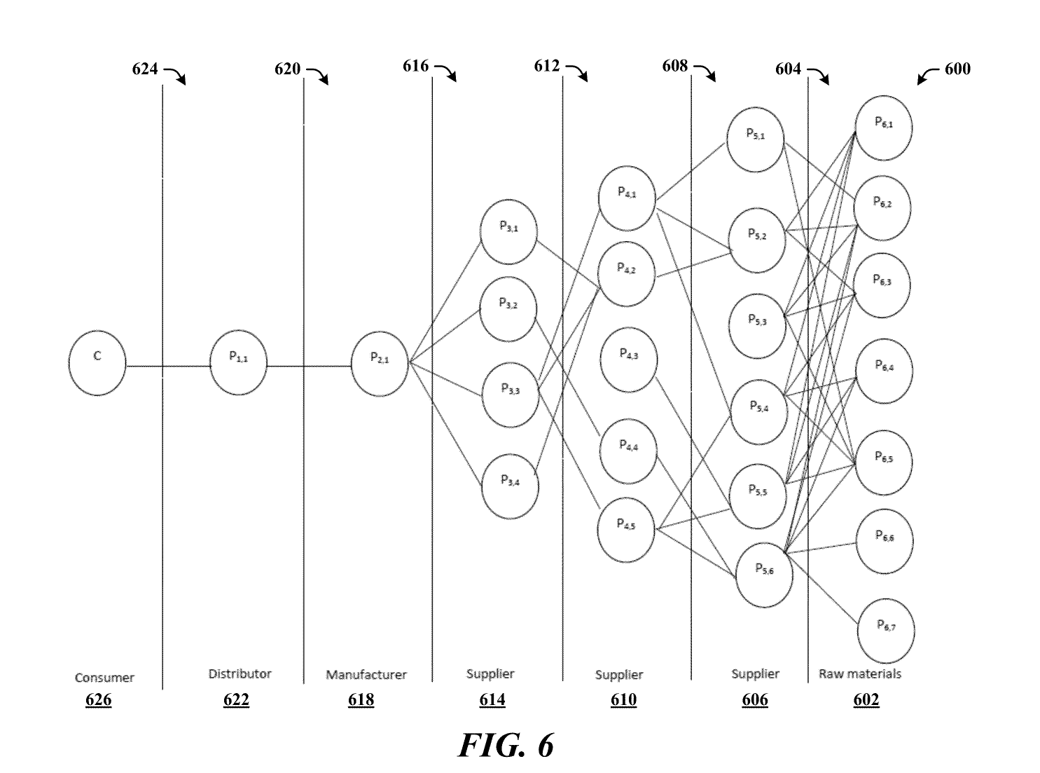

FIG. 6 illustrates a graphical depiction of a supply chain 600 (similar to supply chain 108). The supply chain 600 can comprise, from end-to-end, many different tiers and participants (also called entities) leading up to a consumer. The consumer is represented by the letter C, and each participant of a tier is represented by the letter P with subscripts indicating their logical position (tier) in the supply chain 600. For instance, a first participant in a first tier is denoted by P_{1,1}, and a third participant in a fourth tier is denoted by P_{4,3}.

In this example graph, the supply chain 600 comprises six tiers, leading up to the consumer C: in numerically reverse order, the supply chain 600 begins at a sixth tier 602 of sources of raw materials 604 having seven participants P_{6,1-7}, a fifth tier 606 of raw materials suppliers 808 having six participants P_{5,1-6}, a fourth tier 610 of intermediate suppliers 612 having five participants P_{4,1-5}, a third tier 614 of manufacturer suppliers 616 having four participants P_{3,1-4}, a second tier 618 of manufacturers 620 having a single participant P_{2,1}, and a first tier 622 of distributors 624 having a single participant P_{1,1}. It is to be understood that the supply chain 600 can comprise any number of different participants in tier and many different tiers.

Each entity is connected to one or more other entities with tie lines (links), which indicate a supplier relationship such as, without limitation, that of a consumer to a retailer, a distributor to a manufacturer, a components manufacturer to a raw materials supplier, a smelter to a mining company, etc.

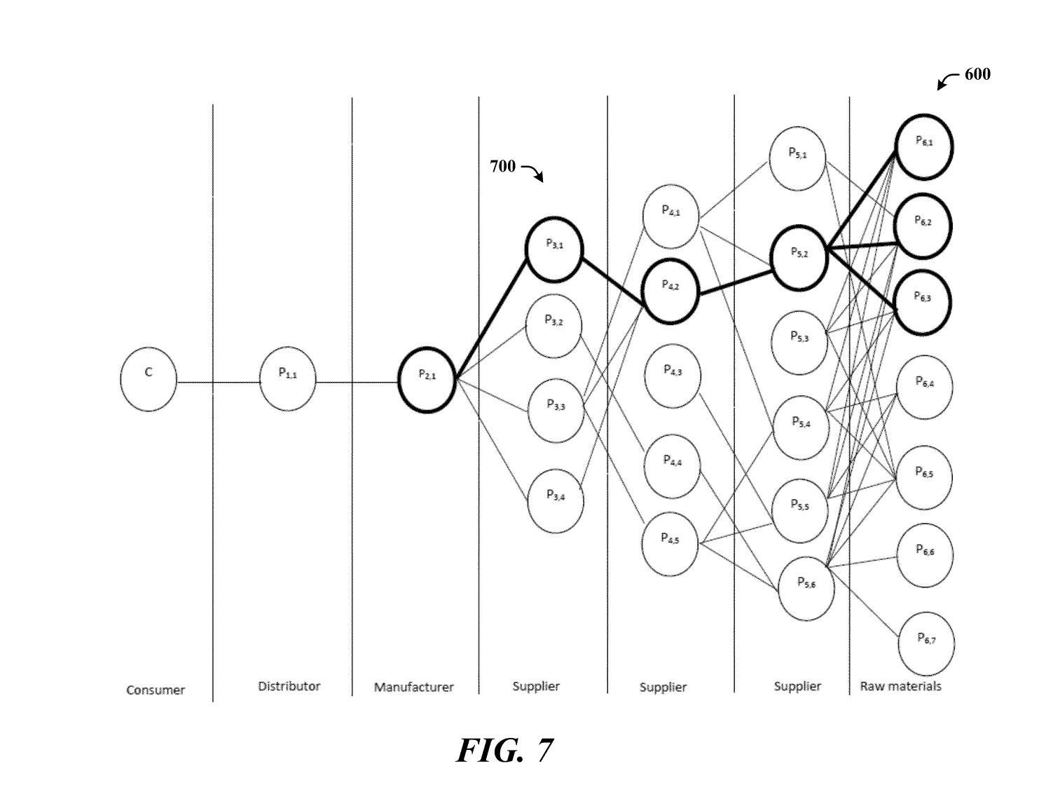

FIG. 7 illustrates a validation chain 700 (in bold) in the supply chain 600 according to an embodiment. A validation chain is defined by a pathway of participants of various tiers over which a compliance check is performed. Here, a validation chain comprises the manufacturer P_{2,1}, a first manufacturer supplier P_{3,1}, a second intermediate supplier P_{4,2}, a second raw materials supplier P_{5,2}, and three raw materials participants P_{6,1}, P_{6,2}, and P_{6,3}. As shown, the manufacturer P_{2,1} may interrogate the centralized compliance database to determine the compliance status of its suppliers, but it may also request manufacturer supplier P_{3,1} verify the compliance of its suppliers (intermediate supplier P_{4,2} and raw materials supplier P_{5,2}). This begins the validation chain, wherein each upstream (moving to the raw materials tier) participant checks its suppliers against the central compliance database until the entire chain 700 is validated back to the raw materials suppliers P_{6,1}, P_{6,2}, and P_{6,3}. Accordingly, the manufacturer P_{2,1} may obtain verification of compliance from every participant upstream from its manufacturer supplier P_{3,1}.

It can also be the case, that the chain can be operated in the reverse direction, downstream to the manufacturer P_{2,1}. Thus, for example, the intermediate supplier P_{4,2} can request compliance downstream to its manufacturer supplier P_{3,1} and the manufacturer P_{2,1}. Thus, validation can occur from any participant and in any direction or both directions (upstream and/or downstream). Additionally, a single participant can request validation of multiple participants of the different tiers, and to which participants are connected. For example, a raw materials supplier

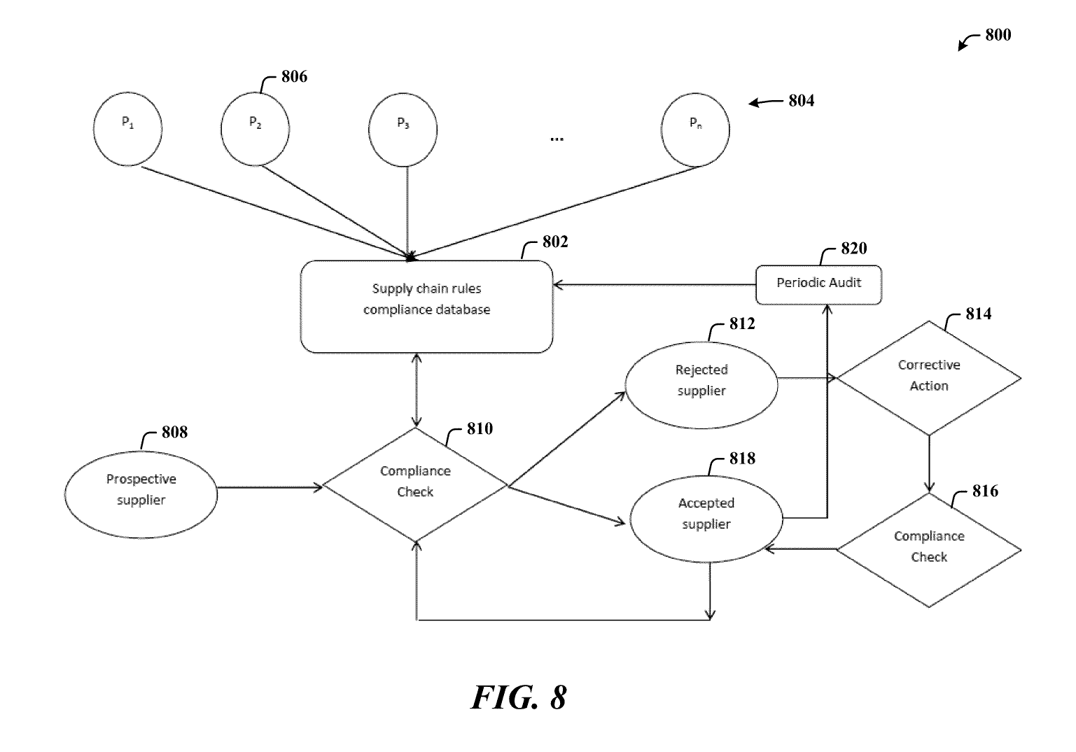

FIG. 8 illustrates a graphical representation 800 of validating and monitoring the compliance status of prospective suppliers. In this example, a compliance database 802 (similar to databases 102 and database 216) is provided that receives records and the compliance status of each participant of participants 804 (similar to the participants 106) in a supply chain 804. When a supply chain participant (e.g., a participant 806) wishes to engage a new (prospective) supplier 808, participant 806 conducts a compliance check 810. If the compliance status of the prospective supplier 806 is noncompliant or the database 802 contains no record of the prospective supplier 808, the prospective supplier 808 is flagged for further review, which may include rejection 812.

However, rejection can be reconsidered by performing a corrective action 814, followed by a compliance check 816 (similar to compliance check 810), to attain status as an accepted supplier 818. If the compliance status from the compliance check 810 is determined to be compliant, then the supplier is the accepted supplier 818. However, as shown in FIG. 8, the status of the accepted supplier 818 can be checked periodically according to periodic audits 820.

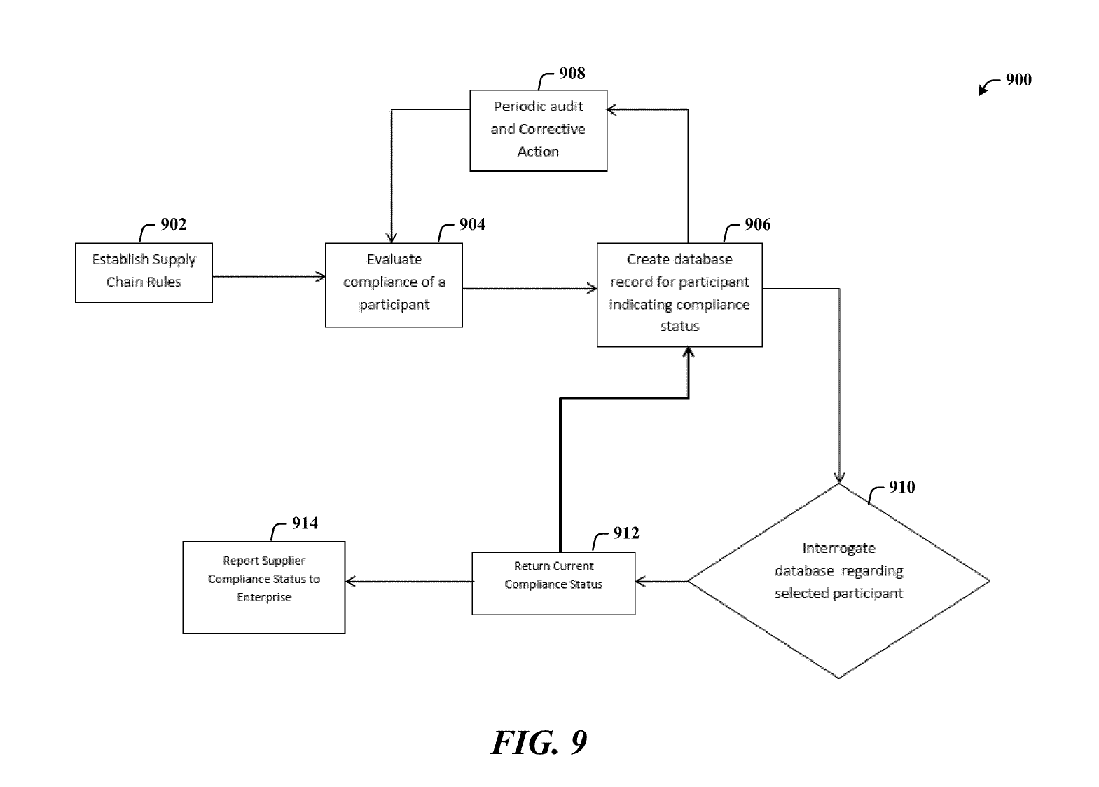

FIG. 9 illustrates a flow diagram 900 of the population and interrogation of a database. At 902, a set of supply chain rules is established which participants in the supply chain must follow in order to be deemed in compliance. At 904, each participant is evaluated for compliance, and at 906, a record is generated in the database indicating the compliance status. At 908, each participant, such as a supplier, is subject to periodic audits, system and control evaluations, document reviews, monitoring of required certifications to ensure they are valid, and other methods to confirm continued compliance. Database records will be updated accordingly. Thus, at 910, when a supply chain participant interrogates the database to determine the compliance status of a selected participant, at 912, the current compliance status (compliant or non-compliant) can be returned not only to the database, at 906, but also the enterprise, at 914.

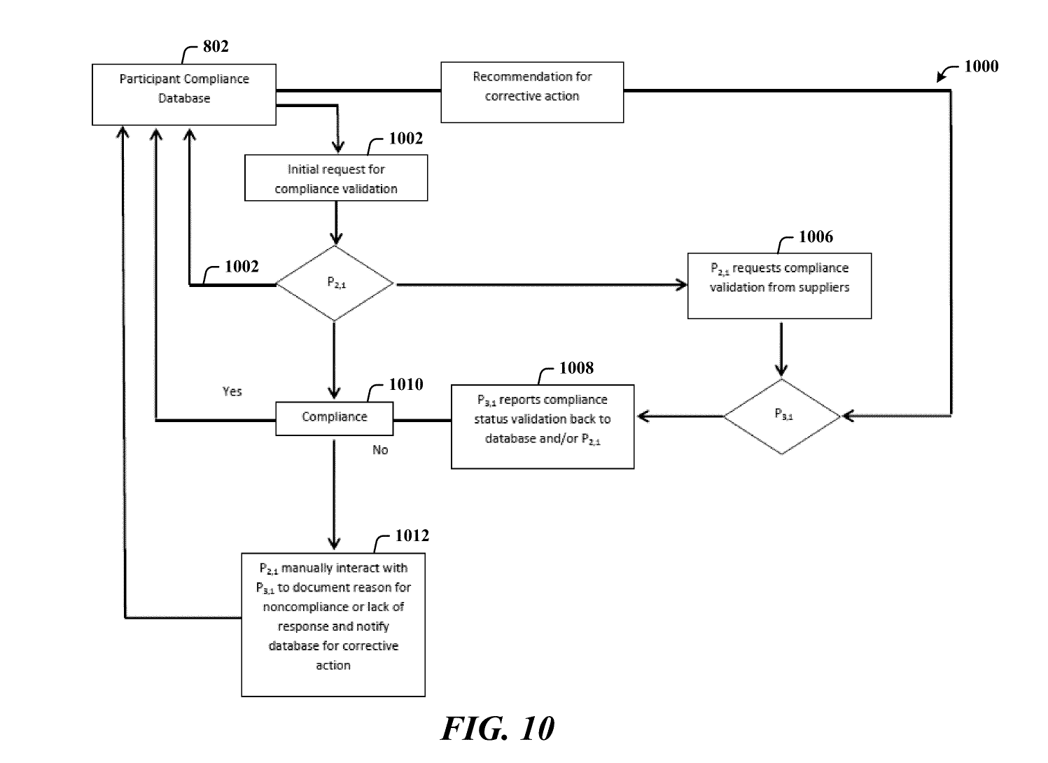

FIG. 10 illustrates a flow diagram 1000 of compliance validation of a portion of the validation chain 700 shown in FIG. 7. Here, the manufacturer participant P_{2,1} initiates a request 1002 to the database 802 for the compliance status of participant P_{3,1}, which is the one of the manufacturer suppliers. The response 1004 to the initial request for compliance validation is then returned to manufacturer participant P_{2,1}.

Additionally, manufacturer participant P_{2,1} sends a request 1006 for compliance validation from its suppliers, such as manufacturer supplier participant P_{3,1}, to verify the compliance status of each of its suppliers, and reports back, at 1008, to P_{2,1} as, well as report back to the central database 802. At 1010, if there is compliance, the result is sent back to the database 802 to update the appropriate records. If non-compliant, flow is from 1010 to 1012, where P_{2,1} can manually interact with supplier P_{3,1} to document the reasons for non-compliance or lack of response, and then notify the database 802 of the status and for corrective actions to be taken. Similar to FIG. 7, the validation process can continue all the way back to the sources (suppliers) of raw materials.

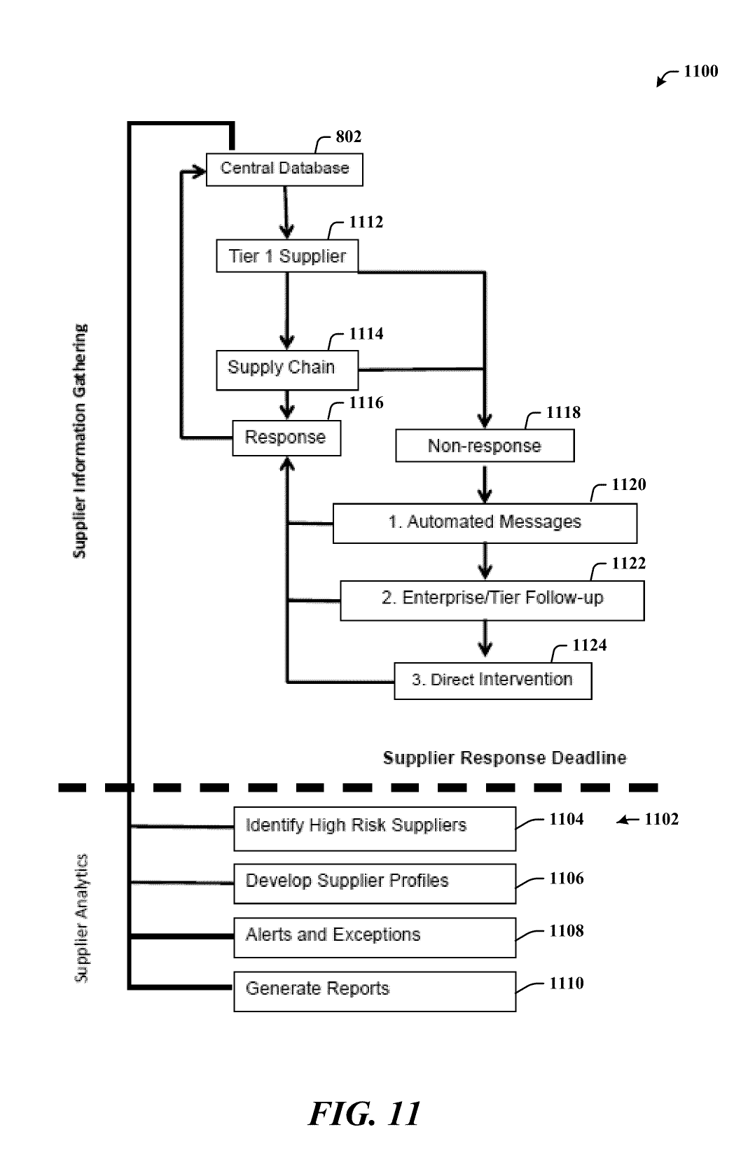

FIG. 11 illustrates a reporting methodology 1100 according to one embodiment, wherein a set of supplier analytics 1102 is in communication with the central database 802. The analytics 1102 may include algorithms/components configured to identify high-risk suppliers 1104, develop and maintain supplier profiles 1106, generate compliance alerts and exceptions 1108, and generate various reports 1110.

As shown, a Tier-1 supplier 1112 queries its supply chain 1114. The supply chain 1114 may respond (response 1116) to the query by reporting back to the central database. However if no response 1118 is received after a predetermined period then the queried supply chain participants receive automated messages 1120 from a system of the embodiment. If the supply chain member does not respond to the automated messages 1120 then one or more upstream participants (enterprise/tier follow-up 1122) in the supply chain may personally contact the nonresponsive participant. If personal attempts to make contact are ineffective at prompting a response then an authority controlling the central database may intervene (direct intervention 1124). According to the embodiment shown in FIG. 11 a predetermined deadline for response may be reached wherein participants in the supply chain may be notified of the nonresponsive participant's noncompliant status. This may prevent the nonresponsive participant from participating in the supply chain until demonstrating compliance.

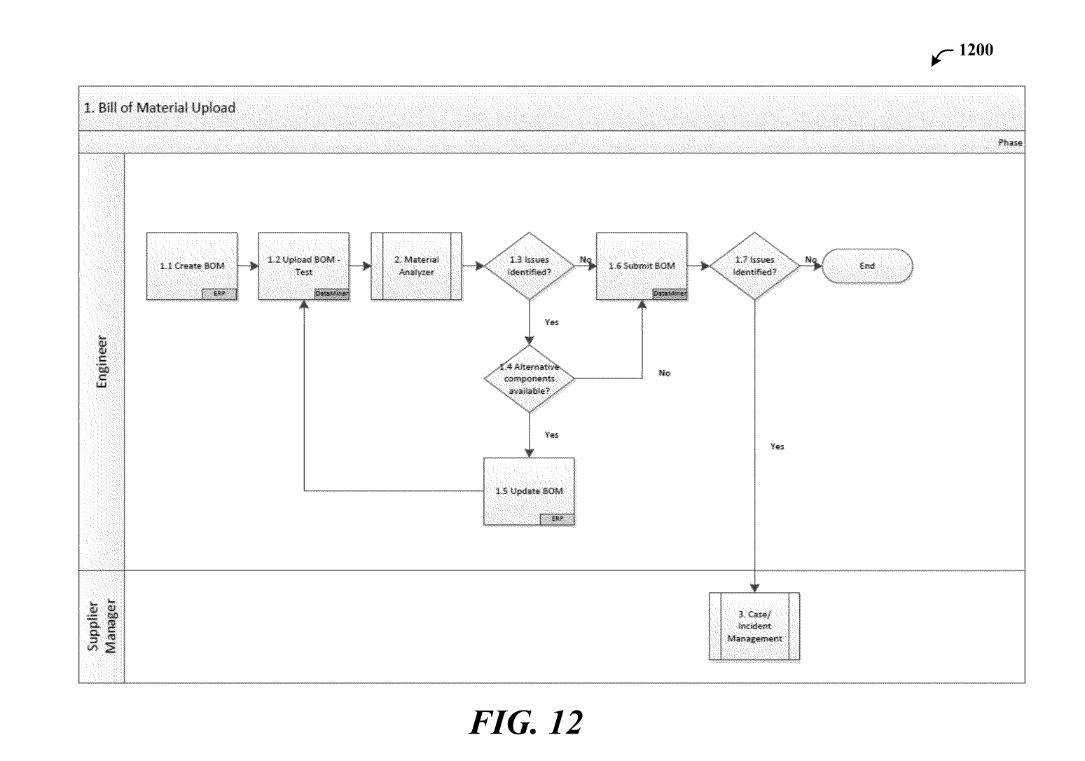

FIG. 12 illustrates a bill-of-materials (BOM) flow diagram 1200. A BOM module facilitates the creation of the BOM in the ERP and testing of a BOM for a supplier by the central database. The BOM is uploaded to the central database, and processed through the material analyzer to detect any issues. If issues are detected, flow is to find alternative available components. If available, flow is then to update the BOM in the ERP, and flow is then back to the central database to again test the BOM. If no issues are detected, flow is to then submit the BOM by the central database. It can be the case that if no alternative components are available upon the first issue detection, that flow is then to the central database where the BOM is submitted. In either case, a second issue detection check is performed. If no other issues are detected, the analyzer process ends for this BOM. However, if another issued is detected, flow is to the supplier manager as a case incident that needs to be addressed by the supplier manager.

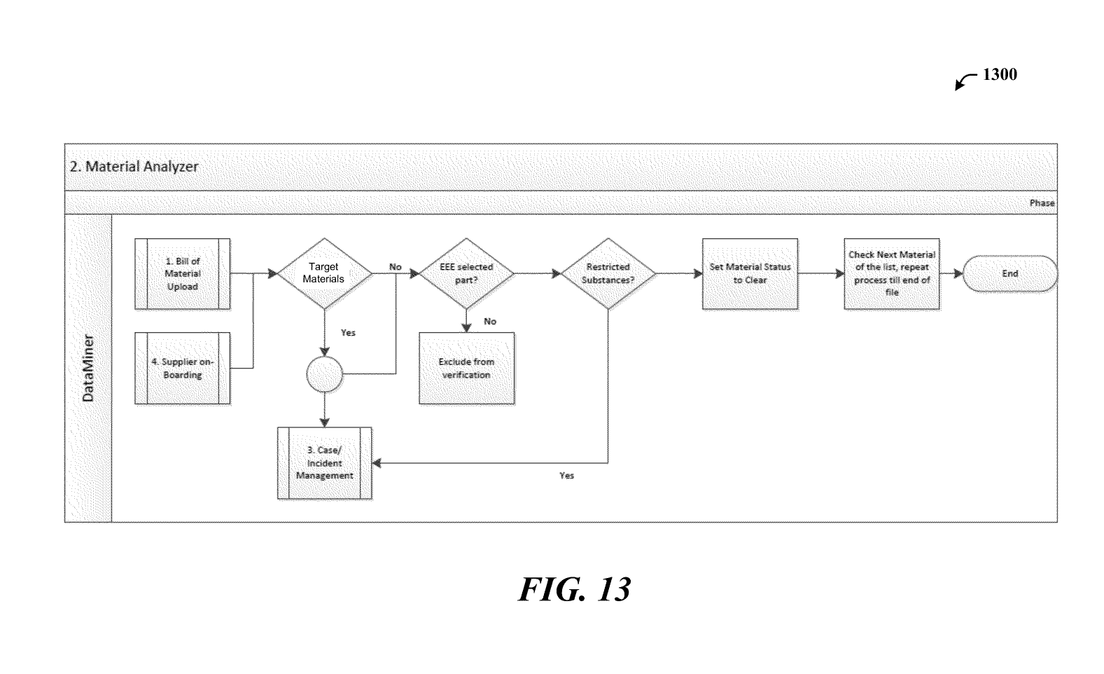

FIG. 13 illustrates a flow diagram 1300 of an exemplary material analyzer. The BOM and output of the supplier on-boarding module are input for material analysis to check for target materials (e.g., conflict minerals such as 3T (tantalum, tin, and tungsten) and gold). If such materials are part of the supplier, flow is to an authority to review the supplier. If the authority determined there may be a problem with the supplier dealing with these materials, a case incident is created and again sent to the supplier manager for notification. If the BOM does not include the target materials (e.g., 3T and gold), flow is to check for an EEE (electrical, electronic, and electromechanical) selected part. If not an EEE part, no further verification is needed. However, if an EEE part, flow is to check if it is or has a restricted substance. If yes, flow is back to include this in the case incident report sent back to the supplier manager. If no restricted substances, flow continues to set the material status as cleared. This material analyzer process continues for each item on the supplier list, and eventually terminates the analyzer process for this supplier.

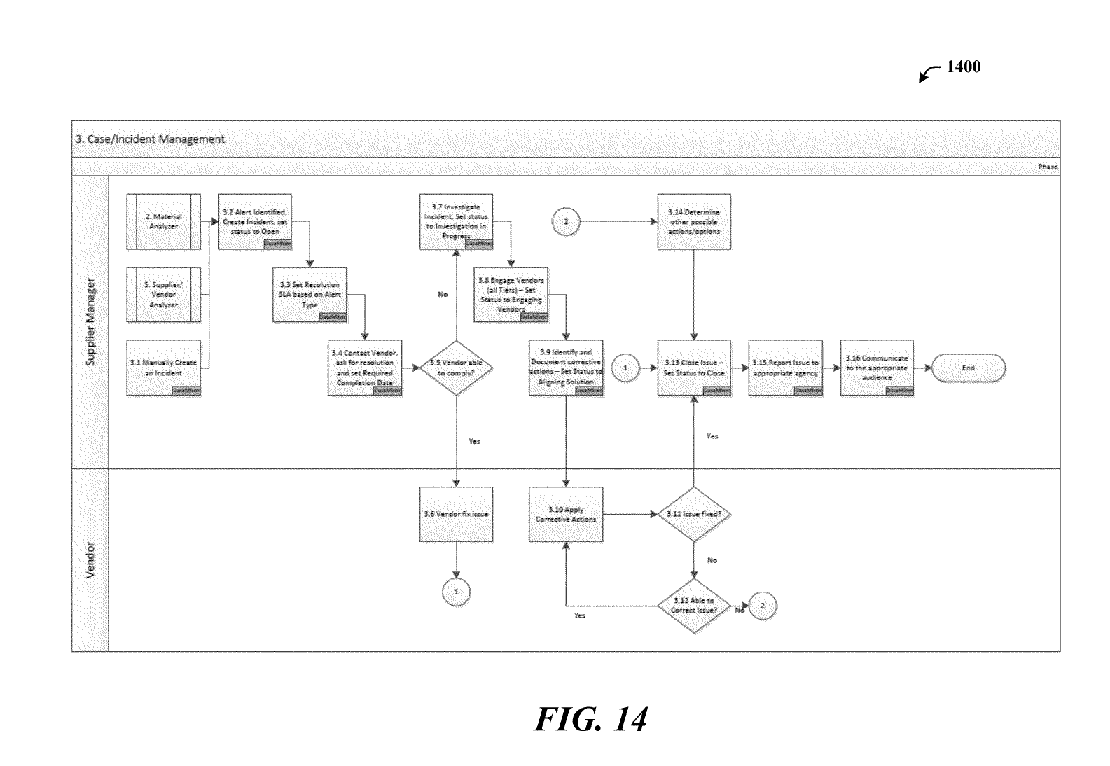

FIG. 14 illustrates a flow diagram 1400 of case and incident management. As part of the case management module, the supplier manager receives output from the material analyzer, the supplier/vendor analyzer, and a created incident (e.g., manually). The central database creates an alert based on the identified incident, creates the incident, and sets the incident record to open status. The resolution SLA (service level agreement) is set based on the alert type. The database then contacts the supplier and requests resolution within a required completion date. If the supplier complies within the set time, and fixes the issue, the database sets the incident to closed status, and a report is issued to the appropriate agency, and is then communicated to the appropriate users.

If the supplier does not comply, an investigation is opened and the incident record is annotated with investigation in process. The suppliers of all tiers are then engaged, and the database record is set to engaging vendors. Corrective actions are identified and documented, and the database record is set to aligning solution. The vendor/supplier is then tasked with applying the corrective actions. If the issue is fixed, flow is to, as before, closing the issue and setting the record status to closed. If the issue is not fixed, flow is then to determine if the issue can be corrected. If yes, flow is then to apply the correction(s), and take the path to close the issue and set the record status to closed. If the issue cannot be corrected, flow is to determine other possible actions or options, and then to close the issue and set the record status to closed.

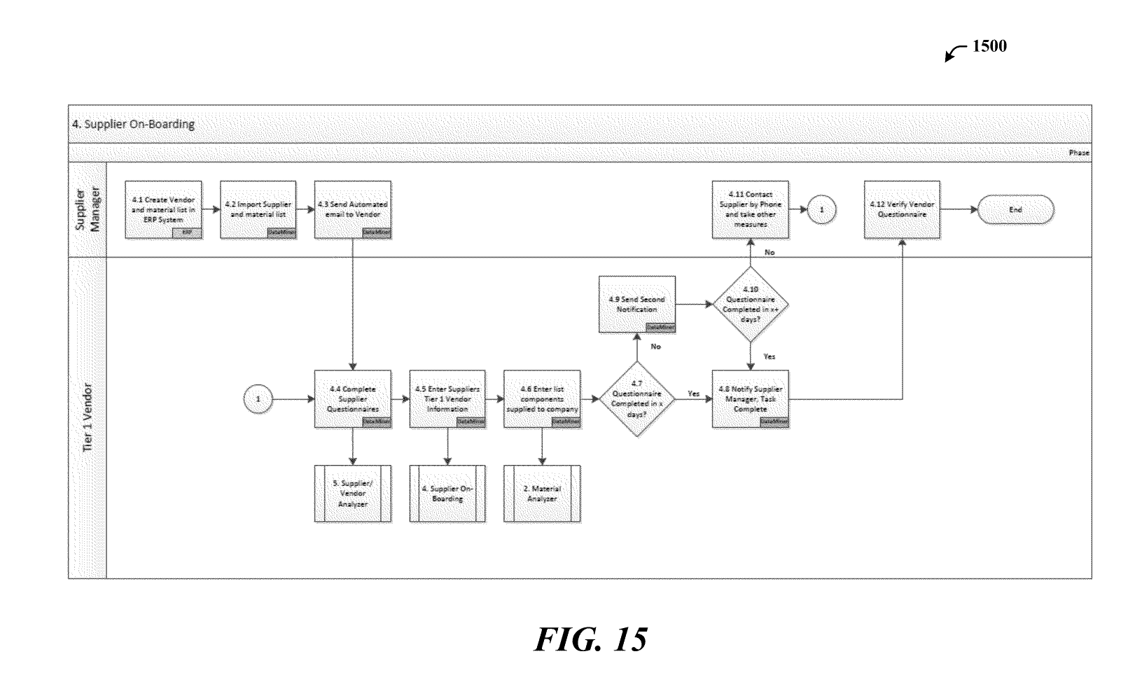

FIG. 15 illustrates a supplier on-board flow diagram 1500. Initially, a vendor and material list is created in an ERP system. The ERP system communicates the supplier and materials list to the central compliance database, and sends an automated email to the vendor. The Tier1 vendor completes a questionnaire in the central database and submits the completed questionnaire to the supplier analyzer. The central database stores the vendor information and forwards the vendor information to the supplier on-boarding module. The central database enters and stores the list of components supplied to the company, and this information can also be provided to the material analyzer. A check is made to determine if completed within the stipulated time frame. If not, a notification is sent, and another check is made for completion. If still not completed, the vendor is contacted by telephone, and other measure may be taken to obtain the desired information. If ultimately completed, the supplier manager is notified of successful completion and the questionnaire s verified. The process then ends.

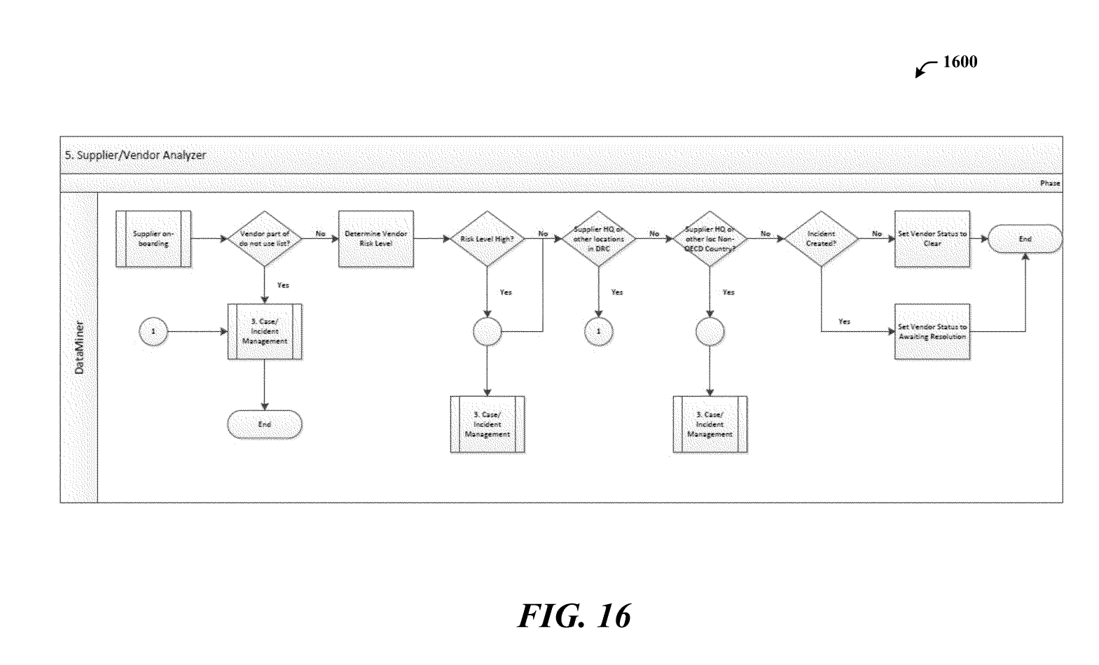

FIG. 16 illustrates a flow diagram 1600 of an exemplary supplier/vendor analyzer. The supplier/vendor analyzer of the central database receives output from the supplier on-boarding module. A first check is made to determine if the vendor is on a do-not-use list (or prohibited vendor list). If yes, flow is to the case/incident manager. If the vendor is not on the prohibited supplier list, flow is to compute the vendor risk level, and then a number of checks to vet the supplier. If the supplier is a high risk, flow is to an authority or authorization entity that then needs to review the supplier information and decide if the supplier vetting can proceed to the next steps. At this point, the authority or authorization entity can submit the supplier to the case/incident manager.

If the authority or authorization entity determines the supplier can be further considered, flow is to determine if the supplier headquarters (HQ) and/or other locations in the DRC (Democratic Republic of the Congo). If so, flow is again to the authority or authorization entity that then needs to review the supplier information and decide if the supplier vetting can proceed to the next steps. At this point, the authority or authorization entity can submit the supplier to the case/incident manager.

Alternatively, if the authority or authorization entity determines the supplier can be further considered, flow is to determine if the supplier headquarters (HQ) and/or other locations in the OECD (Organization of Economic Co-operation Development) countries. If so, flow is again to the authority or authorization entity that then needs to review the supplier information and decide if the supplier vetting can proceed to the next steps. At this point, the authority or authorization entity can submit the supplier to the case/incident manager.

Alternatively, if the authority or authorization entity determines the supplier can be further considered, flow is to determine if an incident needs to be created. If not, the vendor status is set to clear and the analysis ends. Alternatively, if an incident has been created, the associated vendor record status is set to awaiting resolution, and the analysis ends.

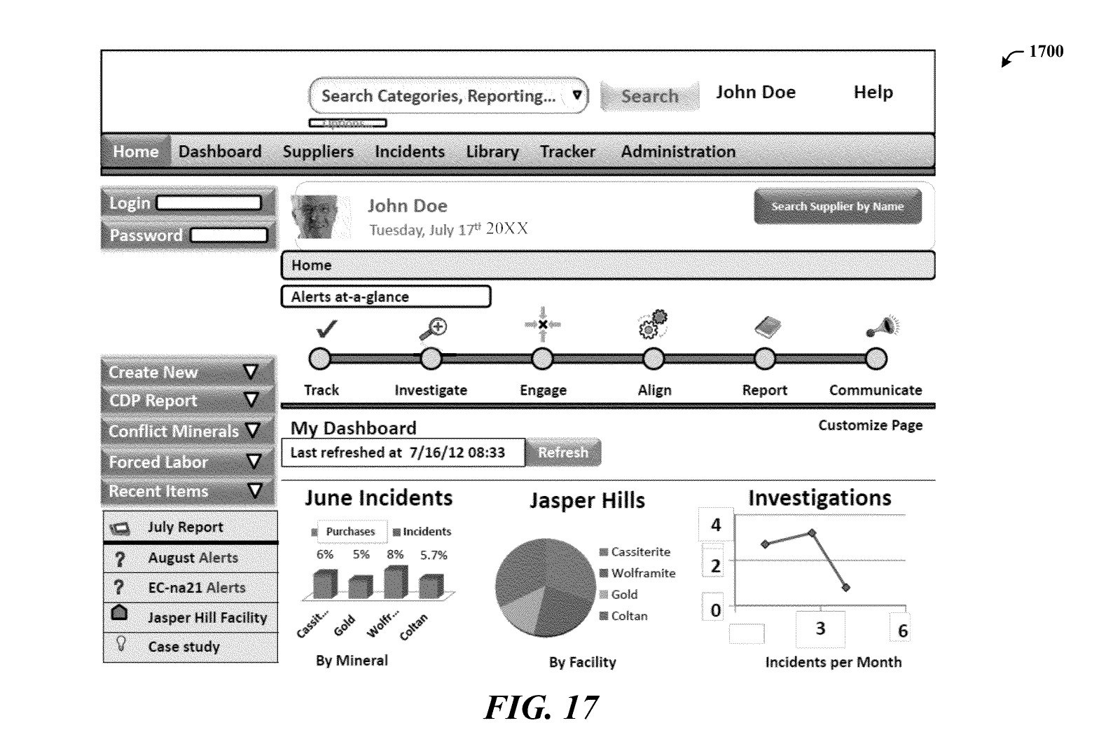

FIG. 17 illustrates an exemplary user interface 1700 for presenting supply chain information. The UI 1700 enables the presentation of a dashboard, suppliers, incident reports, a library, a tracker, and administration for a given supply chain participant. Additionally, a supply chain participant can log-in for secure access to other information. The UI 1700 enables a user to create a new report, look at conflict minerals, data, forced labor data, and so on. A progress graphic is presented that shows progress related to tracking, investigation, engaging, aligning, reporting, and communicating.

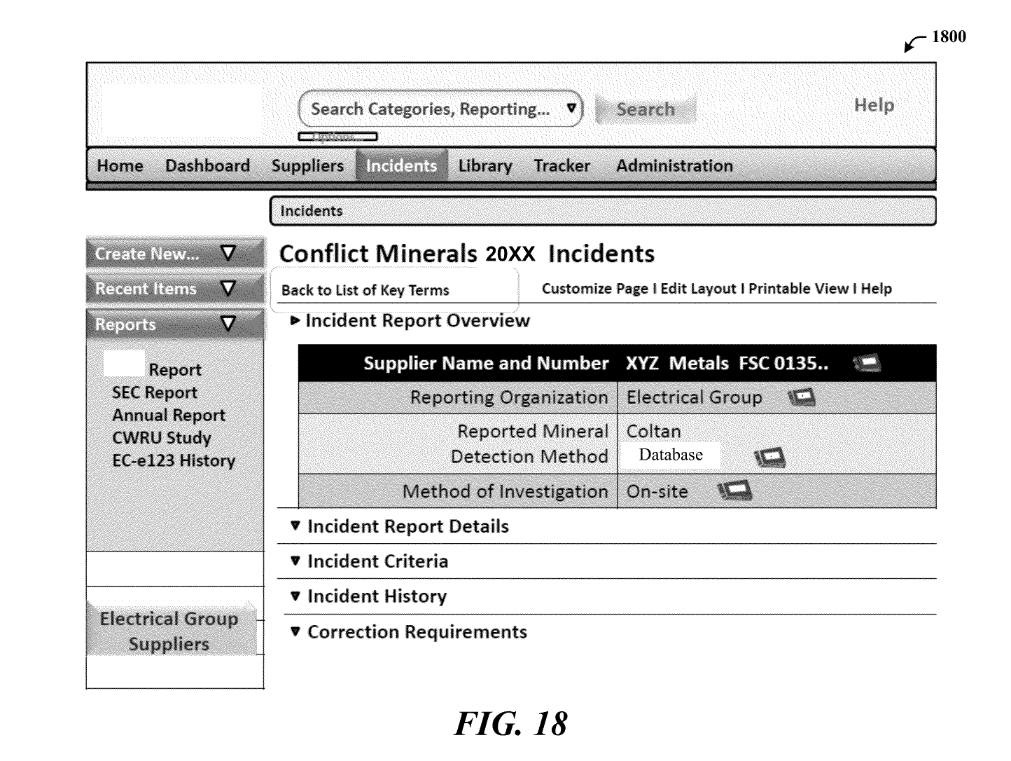

FIG. 18 illustrates an exemplary user interface 1800 that shows a conflict minerals incident report for a year time span. From this UI 1800, the user can display an incident report overview, and further access incident report details, incident criteria, incident history for a given supplier, correction requirements, and report generated.

As used in this application, the terms “component”, “module”, and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

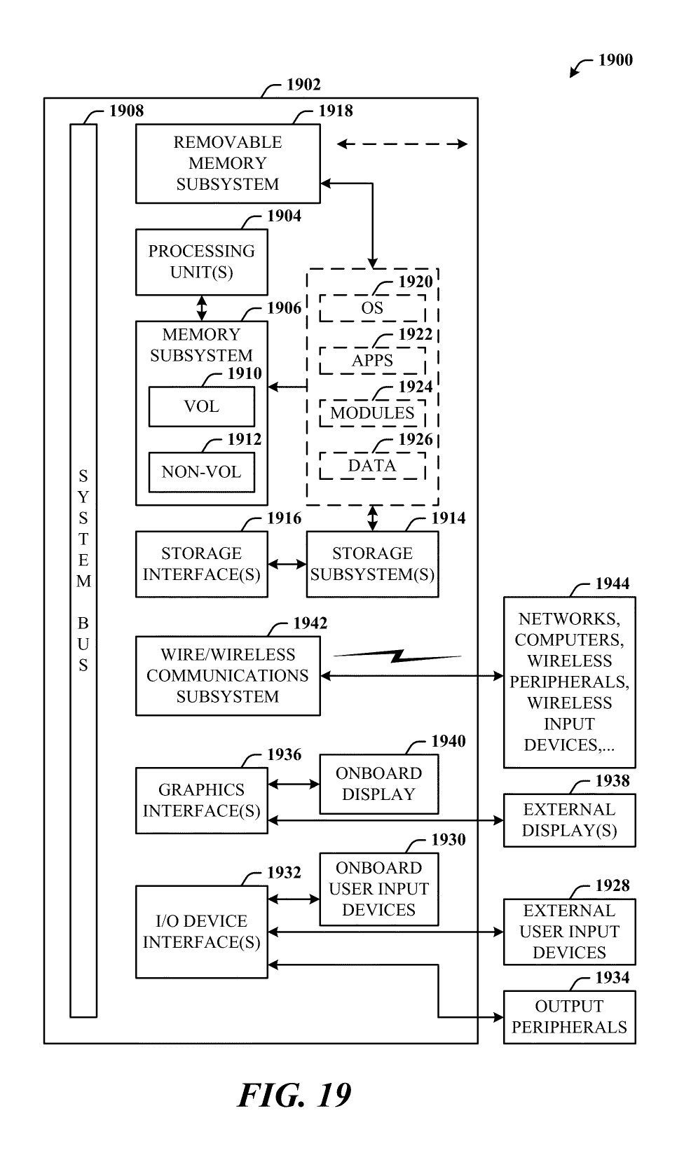

Referring now to FIG. 19, there is illustrated a block diagram of a computing system 1900 that executes the supply chain architecture in accordance with the disclosed architecture. In order to provide additional context for various aspects thereof, FIG. 19 and the following description are intended to provide a brief, general description of the suitable computing system 1900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1900 for implementing various aspects includes the computer 1902 having microprocessing unit(s) 1904 (also referred to as microprocessor(s) and processor(s)), a computer-readable storage medium such as a system memory 1906 (computer readable storage medium/media also include magnetic disks, optical disks, solid state drives, external memory systems, and flash memory drives), and a system bus 1908. The microprocessing unit(s) 1904 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1902 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1906 can include computer-readable storage (physical storage) medium such as a volatile (VOL) memory 1910 (e.g., random access memory (RAM)) and a non-volatile memory (NON-VOL) 1912 (e.g., ROM, EPROM, EEPROM, etc.). A basic input/output system (BIOS) can be stored in the non-volatile memory 1912, and includes the basic routines that facilitate the communication of data and signals between components within the computer 1902, such as during startup. The volatile memory 1910 can also include a high-speed RAM such as static RAM for caching data.

The system bus 1908 provides an interface for system components including, but not limited to, the system memory 1906 to the microprocessing unit(s) 1904. The system bus 1908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1902 further includes machine readable storage subsystem(s) 1914 and storage interface(s) 1916 for interfacing the storage subsystem(s) 1914 to the system bus 1908 and other desired computer components and circuits. The storage subsystem(s) 1914 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1916 can include interface technologies such as EIDE, ATA, SATA, and IEEE 1394, for example.

One or more programs and data can be stored in the memory subsystem 1906, a machine readable and removable memory subsystem 1918 (e.g., flash drive form factor technology), and/or the storage subsystem(s) 1914 (e.g., optical, magnetic, solid state), including an operating system 1920, one or more application programs 1922, other program modules 1924, and program data 1926.

The operating system 1920, one or more application programs 1922, other program modules 1924, and/or program data 1926 can include items and components of the systems, flow diagrams, flow charts, methods, and user interfaces described herein, for example.

Generally, programs include routines, methods, data structures, other software components, etc., that perform particular tasks, functions, or implement particular abstract data types. All or portions of the operating system 1920, applications 1922, modules 1924, and/or data 1926 can also be cached in memory such as the volatile memory 1910 and/or non-volatile memory, for example. It is to be appreciated that the disclosed architecture can be implemented with various commercially available operating systems or combinations of operating systems (e.g., as virtual machines).

The storage subsystem(s) 1914 and memory subsystems (1906 and 1918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1902, and include volatile and non-volatile internal and/or external media that is removable and/or non-removable. For the computer 1902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1902, programs, and data using external user input devices 1928 such as a keyboard and a mouse, as well as by voice commands facilitated by speech recognition. Other external user input devices 1928 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1902, programs, and data using onboard user input devices 1930 such a touchpad, microphone, keyboard, etc., where the computer 1902 is a portable computer, for example.

These and other input devices are connected to the microprocessing unit(s) 1904 through input/output (I/O) device interface(s) 1932 via the system bus 1908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1932 also facilitate the use of output peripherals 1934 such as printers, audio devices, camera devices, and so on, such as a sound card and/or onboard audio processing capability.

One or more graphics interface(s) 1936 (also commonly referred to as a graphics processing unit (GPU)) provide graphics and video signals between the computer 1902 and external display(s) 1938 (e.g., LCD, plasma) and/or onboard displays 1940 (e.g., for portable computer). The graphics interface(s) 1936 can also be manufactured as part of the computer system board.

The computer 1902 can operate in a networked environment (e.g., IP-based) using logical connections via a wired/wireless communications subsystem 1942 to one or more networks and/or other computers. The other computers can include workstations, servers, routers, personal computers, microprocessor-based entertainment appliances, peer devices or other common network nodes, and typically include many or all of the elements described relative to the computer 1902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1902 connects to the network via a wired/wireless communication subsystem 1942 (e.g., a network interface adapter, onboard transceiver subsystem, etc.) to communicate with wired/wireless networks, wired/wireless printers, wired/wireless input devices 1944, and so on. The computer 1902 can include a modem or other means for establishing communications over the network. In a networked environment, programs and data relative to the computer 1902 can be stored in the remote memory/storage device, as is associated with a distributed system. It will be appreciated that the network connections shown are exemplary and other means of establishing a communications link between the computers can be used.

The computer 1902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An supply chain system, comprising:
a compliance database configured to contain records of participants in a supply chain that may comprise a conflict mineral, wherein each participant record includes an indication of whether a participant is in compliance with supply chain management rules for conflict minerals;
supply chain management rules configured to compare a first participant in the supply chain to the compliance database, wherein a rule indicates compliance status of the first participant related to the supply chain management rules; and
at least one hardware processor configured to execute computer-executable instructions in a memory associated with the compliance database and the supply chain management rules.

2. The system of claim 1, wherein the compliance database further comprises a due diligence module configured to enable risk analysis of a participant of the supply chain as part of due diligence processing, the due diligence module runs routinely to ensure continued compliance of all supply chain participants.

3. The system of claim 1, wherein the compliance database further comprises a reporting module configured to ensure module reporting objectives have been met.

4. The system of claim 1, wherein the compliance database enables compliance auditing from a supply chain participant in either direction of the supply chain.

5. The system of claim 1, wherein the compliance database enables compliance processing based on rules that relate to raw material sources, raw material source locations, and geographical areas proximate the raw materials source.

6. A supply chain method, comprising:
providing a set of supply chain management rules;
providing a compliance database containing records of participants in a supply chain, wherein each participant record includes an indication of whether a participant is in compliance with the supply chain management rules;
comparing a first participant in a supply chain to the compliance database; and
receiving an indication of a compliance status of the first participant with supply chain management rules.

7. The method of claim 6, wherein the participant in a supply chain comprises a network of participants in a supply chain, wherein each participant is individually selected from at least one of a retailer, a distributor of finished goods, a distributor of components, a finished goods manufacturer, a component manufacturer, a raw materials distributor, a raw materials manufacturer, a smelter, or a mining company.

8. The method of claim 7, wherein a plurality of supply chain participants access the compliance database to monitor the compliance status of respective direct and/or indirect suppliers.

9. The method of claim 6, further comprising comparing a material obtainable from a participant supply chain to a list of materials subject to the supply chain management rules.

10. The method of claim 9, further comprising identifying a material obtainable from its supply chain as a material that is subject to the supply chain management rules.

11. The method of claim 10, further comprising identifying at least one record of at least one prospective supplier from the compliance database which supplies the material, and wherein the at least one record includes at least one indicium indicating that the at least one prospective supplier is currently in compliance with the supply chain rules.

12. The method of claim 11, further comprising adding the at least one supplier to a list of preferred suppliers from which supplies are to be purchased.

13. The method of claim 12, further comprising communicating the list of preferred suppliers to at least one purchasing agent within the participant.

14. The method of claim 11, further comprising tracing the material back to an original material source and determining that each participant between the original material source and a selected participant is in compliance with the supply chain management rules.

15. The method of claim 6, further comprising receiving an indication that a participant is noncompliant with the supply chain management rules.

16. The method of claim 15, further comprising calculating an amount of material conveyed from noncompliant participant to a selected participant.

17. The method of claim 15, further comprising calculating the amount of noncompliant material conveyed from a noncompliant participant to a selected participant.

18. The method of claim 17, further comprising a percentage of noncompliant material conveyed to the selected participant.

19. The method of claim 18, further comprising determining the supply chain rules compliance status of the selected participant.

20. A computer-readable storage medium comprising computer-executable instructions that when executed by a hardware processor, cause the hardware processor to perform a supply chain method, comprising acts of:
generating a compliance database of records of participants in a supply chain, wherein each participant record includes an indication of whether a participant is in compliance with supply chain management rules as relate at least to conflict minerals;
applying the supply chain management rules to the supply chain as part of a due diligence process;
initiating corrective actions to an issue detected with a supply chain participant;
generating a report that defines measures taken as to point of origin of materials in the supply chain, chain of custody of the materials in the supply chain, and if the materials are conflict minerals; and
auditing the report using a third party auditor.
